(19) United States
(12) Patent Application Publication
(10) Pub. No.: US 2010/0240800 A1
(43) Pub. Date: Sep. 23, 2010

(54) BIOCIDAL ELASTOMERIC COMPOSITIONS AND METHODS OF MAKING THE SAME

(75) Inventor: Robert Dunham Cunningham, St. Louis, MO (US)

Correspondence Address: HARNESS, DICKEY, & PIERCE, P.L.C, 7700 Bonhomme, Suite 400, ST. LOUIS, MO, 63105, US

(73) Assignee: DASH MULTI-CORP, Maryland Heights, MO (US)

(21) Appl. No.: 12/726,848

(22) Filed: Mar. 18, 2010

Related U.S. Application Data
(60) Provisional application No. 61/162,160, filed on Mar. 20, 2009.

(51) Int. Cl. C09D 5/16

(52) U.S. Cl. 523/122

(57) ABSTRACT

A composition having biocidal properties comprises pre-fabricated elastomeric particles, a biocidal agent, and an adhesive phase combining the elastomeric particles and the biocidal agent, wherein the pre-fabricated elastomeric particles and the adhesive phase are made of different materials, and wherein the biocidal agent is present in the adhesive phase but is substantially absent from the pre-fabricated elastomeric particles. Elastomeric compositions or products of this disclosure are useful to prevent communicable diseases resulting from bodily exposure to pathogenic bacteria such as Staphylococcus aureus and Methicillin-Resistant Staphylococcus aureus (MRSA) strains.

### CROSS REFERENCE TO RELATED APPLICATION

This application claims the benefit of U.S. provisional application Ser. No. 61/162,160 filed Mar. 20, 2009. The disclosure of the application is hereby incorporated by reference.

### FIELD

The present disclosure generally relates to compositions containing elastomeric particles, methods of preparing such compositions, and elastomeric products containing such compositions. More particularly, the present disclosure relates to compositions having biocidal properties, preparing such compositions, and biocidal elastomeric products.

### BACKGROUND

This section provides background information related to the present disclosure which is not necessarily prior art.

Elastomeric materials can be used for the manufacture of a wide variety of articles, and elastomeric products therefore can be found virtually everywhere. For example, elastomers or rubbers are the major component of, or added to, various articles such as hoses, appliances, equipment, tires, flooring mats, protective covers, and household items. Elastomeric or rubber products are indispensable to our daily life and are constantly exposed to contamination with various microorganisms including pathogenic bacteria and fungi. It is well known that microorganisms cause many infectious diseases. Transmission of an infectious disease is often linked to contact with contaminated articles found in heavily trafficked or public areas such as gymnasiums, playgrounds or hospitals. One solution to this problem is to apply sanitizers to such places when necessary, which requires inconvenient, unreliable, and costly periodic maintenance. Accordingly, consumer elastomeric or rubber products having biocidal properties could prevent communicable diseases resulting from bodily exposure to microbially-inhabited surfaces.

U.S. Pat. No. 6,455,610 describes a raw rubber formulation containing a rubber constituent, a silver-based antimicrobial compound, and a curing compound that does not include an appreciable amount of sulfur-based compounds. The formulation optionally contains a blowing agent, a silver ion release control additive and an antifungal additive other than the silver-based antimicrobial compound.

U.S. Pat. No. 7,098,256 describes a radiation-curable polymeric coating comprising a radiation cross-linkable oligomer, a radiation cure package, an antimicrobial agent, a cross-linking agent, and optionally, an additive package. The radiation curable polymeric coating is prepared by incorporating antimicrobial agent into a polymer prior to a cross-linking process.

WO 2005/053397 mentions a process for incorporating an antimicrobial agent onto the surface of a metal-containing plastic product. In the process, a metal-containing plastic-forming composition is extruded or molded into a product at an elevated temperature, and a biocide is subsequently incorporated onto the outer surface of, or into the porous inner portion of, the product through cooling the extruded or molded object with an aqueous solution containing an antimicrobial agent. Contacting of the fully polymerized object with the aqueous biocide solution causes the antimicrobial agent to react or chelate with at least a portion of the metal on an outer surface, or in a porous inner portion, of the object, thereby forming an anti-microbially protected plastic product containing a water-insoluble metal salt of the biocide.

### SUMMARY OF THE INVENTION

This section provides a general summary of the disclosure, and is not a comprehensive disclosure of its full scope or all of its features.

In one embodiment, there is provided an elastomeric composition having biocidal properties comprising pre-fabricated elastomeric particles, a biocidal agent, and an adhesive phase combining the elastomeric particles and the biocidal agent, wherein the pre-fabricated elastomeric particles and the adhesive phase are made of different materials, and wherein the biocidal agent is present in the adhesive phase but is substantially absent from the pre-fabricated elastomeric particles.

In another embodiment, there is provided a method for preparing a rubber composition, comprising: (a) preparing elastomeric particles; (b) mixing a biocidal agent, an adhesive phase and the elastomeric particles together to form a mixture; and (c) curing the mixture of step (b).

In yet another embodiment, there is provided an elastomeric sheet having biocidal properties comprising a composition containing, by weight, about 78% to about 98% of elastomeric particles; about 2.0% to about 22% of an adhesive phase; and about 0.05% to about 2% of a biocidal agent, wherein the elastomeric particles are fabricated before being added to the rubber composition, wherein the elastomeric particles and the adhesive phase are made of different materials, and wherein the biocidal agent is present in the adhesive phase but is substantially absent from the elastomeric particles.

Further areas of applicability will become apparent from the description provided herein. This summary is intended for purposes of illustration only and is not intended to limit the scope of the present disclosure.

### BRIEF DESCRIPTION OF DRAWINGS

The figures described herein are for illustrative purposes only of selected embodiments and not all possible implementations, and are not intended to limit the scope of the present disclosure.

FIGS. 1-A to 1-C show log reduction of various microorganisms when contacted with elastomeric compositions containing zinc pyrithione in accordance with the present disclosure for 1, 2, 4 and 24 hours.

FIGS. 2-A to 2-C show log reduction of various microorganisms when contacted with elastomeric compositions containing N-butyl-1,2-benzisothiazolin-3-one in accordance with the present disclosure for 1, 2, 4 and 24 hours.

FIGS. 3-A to 3-C show log reduction of various microorganisms when contacted with elastomeric compositions containing silver in accordance with the present disclosure for 1, 2, 4 and 24 hours.

### DETAILED DESCRIPTION

The present disclosure provides a composition having biocidal properties, a method for preparing such compositions, and elastomeric products having biocidal properties. Particularly, in an embodiment, there is provided a composition comprising elastomeric particles, a biocidal agent, and an adhesive phase combining the elastomeric particles and the biocidal agent. A composition in accordance with the present disclosure is useful to manufacture an elastomeric product which kills, or prevents proliferation of, pathogenic microorganisms on the surface of the product.

In an embodiment, an elastomeric composition in accordance with the present disclosure comprises elastomeric particles, a biocidal agent, and an adhesive phase combining the elastomeric particles and the biocidal agent, wherein the elastomeric particles are fabricated before being added to the elastomeric composition, wherein the elastomeric particles and the adhesive phase are made of different materials, and wherein the biocidal agent is present in the adhesive phase but is substantially absent from the elastomeric particles.

The term, “substantially absent”, is intended to describe a state where a biocidal agent does not exist in elastomeric particles at all or a trace amount of a biocidal agent exists in elastomeric particles. However, the term allows the presence of a biocidal agent on the surface of elastomeric particles.

The elastomeric particles to be used are “pre-fabricated” for use in making an elastomeric composition. The term, “pre-fabricated” particles, means a collection of particles comprising polymerized monomeric elastomeric materials, which particles are fabricated prior to preparation of compositions of the invention. “Pre-fabricated” particles are formed, for example, when monomeric elastomeric materials are polymerized to form an elastomeric solid and then granulated prior to preparation of the composition. The granulation may involve a step of chopping, grinding, cutting or abrading the elastomeric solid into a particulate mixture. Alternatively, pre-fabricated elastomeric particles can be produced by granulating reclaimed elastomeric materials such as tires, gaskets and molded goods. An example of such particles is crumb rubber that is recycled rubber from, for example, automotive and truck scrap tires. A variety of crumb rubbers are available from other recycling sources and commercial providers.

Generally, a wide range of sizes of elastomeric granules may be used in a composition of the present disclosure. Under certain circumstances, depending on the characteristics of a final product, it may be necessary or advantageous to control the granule size. For example, selection of a certain particle size distribution could result in production of an elastomeric product having optimum packing density. Where necessary, granules are sized by passing through a screen and the size is based on a dimension (e.g., particle size distribution). Specific particle sizes used in this disclosure, therefore, are maximum sizes corresponding to passing a sieve. A proper range of granule size for a certain composition can be determined by a person having ordinary skill in the art on a case-by-case basis. In an embodiment, elastomeric particles are less than about 10.0 mm, more particularly less than about 5.0 mm in diameter or length. In another embodiment, elastomeric particles included in a composition of this disclosure are about 0.2 to about 10.0 mm, particularly about 0.2 to about 5.0 mm. In yet another embodiment, an elastomeric composition is prepared by blending two or more different sizes of elastomeric particles, e.g., 10 mesh crumb rubber and 20 mesh crumb rubber, to achieve optimum packing density.

In various embodiments, elastomeric particles comprise natural rubber, synthetic rubber, non-rubber elastomers or a mixture thereof. Generally, any conventional elastomeric materials can be employed for preparing compositions in accordance with the present disclosure. Examples of such elastomeric materials include, but are not limited to, natural rubber, butadiene rubber, chloroprene rubber, chlorosulfonylpolyethelene rubber, epichlorohydrin rubber, ethylene-propylene diene (EPDM) rubber, ethylene vinyl acetate rubber, halo-butyl rubber, isobutene-isoprene rubber, nitrile-butadiene rubber, polyisoprene rubber, styrene-butadiene (SBR) rubber, styrene-isoprene rubber, thermoplastic rubbers based on polyolefins, polyesters, styrene-butadiene polymers, polyurethanes, non-thermoplastic polyurethane rubbers, and plasticized polyvinyl chloride. In an embodiment, elastomeric particles are polymerized rubbers made from rubber monomers, particularly vulcanized rubbers. In a particular embodiment, elastomeric particles contain EPDM, SBR or a mixture of both.

Prefabricated elastomeric particles may further contain one or more pigments intentionally incorporated to change the color of the particles or impart other characteristics such as flame retardancy. The term “pigmented particle” or “pigmented elastomeric particle,” as used herein, therefore, refers to a particle or elastomeric particle containing at least one pigment intentionally incorporated to impart color or other specific characteristics. In an embodiment, a composition of the present disclosure optionally contains pigmented elastomeric particles in addition to recycled elastomeric particles.

A present elastomeric composition may comprise polymerized elastomeric particles, recycled elastomeric particles, pigmented elastomeric particles, or a mixture thereof. Recycled elastomeric particles and pigmented elastomeric particles in a composition can be made of the same or different elastomeric materials. In an embodiment, a composition comprises pigmented elastomeric particles and recycled elastomeric particles, wherein the pigmented particles and the recycled particles are made of different elastomeric materials. In a particular embodiment, a composition comprises recycled elastomeric particles containing SBR and pigmented elastomeric particles containing EPDM.

An adhesive phase is added to a composition of this disclosure to combine elastomeric particles and a biocidal agent to make an aggregated composition. In an embodiment, an adhesive phase combines the components such that the biocidal agent is present in the adhesive phase but is substantially absent from the elastomeric particles. The elastomeric particles, which are pre-fabricated (e.g., such as crumb rubber), do not contain any biocidal agent inside since a cross-linking or polymerization process is done before contacting a biocidal agent. Thus, an adhesive phase holds the elastomeric particles and the biocidal agent together but typically there is no physical intermixture between the elastomeric particles and the biocidal agent substantially. An adhesive phase of the present disclosure can be any conventional binder appropriate to aggregate elastomeric particles and a biocidal agent. However, the adhesive phase is selected to be different from the elastomeric particles. Examples of an adhesive phase include, but are not limited to, natural adhesives, synthetic adhesives, drying adhesives, contact adhesives, hot adhesives (thermoplastic adhesives), reactive adhesives, UV and radiation-curing adhesives and pressure sensitive adhesives. In an embodiment, the adhesive phase is moisture curable adhesive, and in a particular embodiment, the adhesive phase contains polyurethane.

A composition in accordance with the present disclosure typically contains at least one biocidal agent. The term “biocidal agent,” as used herein, is a chemical substance capable of killing or inhibiting the growth of living organisms, and examples of such an agent include fungicides, insecticides, miticides, germicides, antibiotics, antibacterials, antivirals, antifungals, antiprotozoals and antiparasites. In various embodiments, a biocidal agent is one or more agents independently selected from the group consisting of pyrithione acid, sodium pyrithione, potassium pyrithione, pyrithione disulfide magnesium sulfate, zinc pyrithione, silver in zeolite matrix, zinc in zeolite matrix, copper in zeolite matrix, tributyl tin oxide (TBTO), tributyl tin maleate (TBTM), para-chloro-xylene, hexachlorophene, 2,4,4′ trichloro-2′-hydroxydiphenyl ether (triclosan), imazalil sulphate, 3,5,3′,4′-tetrachlorosalicylanilide, N-nitroso-N-cyclohexyl hydroxylamine, 8-hydroxyquinoline, copper-8-hydroxy quinolinate, thiocarbamates, dithiocarbamates, zinc dimethyldithiocarbamate, 5-chloro-2-(2,4-dichlorophenoxy)phenol, polyhexamethylene biguanide hydrochloride, 2-phenylphenol, diiodomethyl-4-tolylsulfone, zinc-2-mercaptopyridine-N-oxide, N-alkyl-N,N-dimethyl-N-benzylammonium chloride, 3-(4-chlorophenyl)-1-(3,4-dichlorphenyl)urea (triclocarban), 2-(1,3-thiazol-4-yl)-1H-benzoimidazole (thiabendazole), 3-iodo-2-prop ynyl N-butylcarbamate, 3-benzo[b]thien-2-yl-5,6-dihydro-1,4,2-oxathiazine 4-oxide, 2-(n-octyl)-3(2H)-isothiazolone (OIT), N-butyl-1,2-benzisothiazolin-3-one, 4,5-dichloro-2-octyl-3(2H)-isothiazolone, 2-methyl-4-isothiazoline-3-one cyclopropyl-N′-(1,1-dimethylethyl)-6-methylthio-1,3,5-triazine-2,4-diamine, 1,3-dicyano-2,4,5,6-tetrachlorobenzene, 3,4,4′-trichlorocarbanilide, 3-(3,4-dichlorophenyl)-1,1-dimethylurea (DIURON), 1 [[2-(2,4-dichlorophenyl)-4-propyl-1,2-dioxolan-2-yl]methyl]-1H-1,2,4-triazole (propiconazole), 10,10-oxybisphenoxy arsine (OBPA), 1-(4-chlorophenyl)-4,4-dimethyl-3-(1,2,4-triazol-1-ylmethyl)pentan-3-ol (tebuconazole), 2-(thiocyanomethylthio) benzothiazole, 2,3,5,6 tetrachloro-4-(methyl sulphonyl)pyridine, 2,4,4-tricloro-2-hydroxydiphenylether, 4-chloro-3,5-dimethyl-phenol, 5-hydroxymethoxymethyl-1-1aza-3,7-dioxabicyclo-octane, 2,4,5,6-tetrachloro-1,3-benzenedicarbonitrile (chlorothalonil), bis(tri-n-butyltin)oxide, N-(fluorodichloromethylthio)phthalimide, N-(trichloromethyl-thio)-4-cyclohexene-1,2-dicarboximide, N,N-dimethyl dichlorophenyl urea, p-chloro-m-cresol, o-phenylphenol, pentachlorophenol, silver compounds, sodium-o-phenyl phenoxide, tebuconazole, tetrachloroisophthalonitrile, tetramethylthiuram disulfide and a mixture thereof. In an embodiment, the biocidal agent is selected from the group consisting of pyrithione acid, sodium pyrithione, potassium pyrithione, pyrithione disulfide magnesium sulfate, zinc pyrithione and a mixture thereof.

In a particular embodiment, a biocidal agent is zinc pyrithione (IUPAC name: bis(2-pyridylthio)zinc 1,1′-dioxide, and CAS number: 13463-41-7), also commercially known as zinc OMADINE®. Zinc pyrithione is a compound having the following structure:

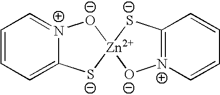

and has antifungal and antibacterial properties effective against many pathogens, for example, from the streptococcus and staphylococcus class.

In another particular embodiment, a biocidal agent is N-butyl-1,2-benzisothiazolin-3-one (CAS number: 4299-07-4) that is a broad-spectrum antimicrobial agent. The biocidal agent is available from a commercial provider. For example, Vanquish™ 100 can be used to prepare a composition containing N-butyl-1,2-benzisothiazolin-3-one.

In yet another particular embodiment, a biocidal agent is silver or a silver-based agent. A particular example of such a biocidal agent is silver in zeolite matrix which may be available from a commercial provider. In an embodiment, an elastomeric composition contains Irgaguard® B-6000 as a biocidal agent including silver.

The proportions of the components of an elastomeric composition can be any ratio so long as the composition maintains biocidal activities and proper resilient characteristics. In an embodiment, a composition of this disclosure comprises an effective amount of a biocidal agent, where the effective amount means an amount enough to kill, or prevent proliferation of, pathogenic microorganisms. In another embodiment, a composition comprises, by weight, about 78% to about 98% of elastomeric particles; about 2.0% to about 20% of an adhesive phase; and about 0.05% to about 2% of a biocidal agent. In yet another embodiment, a composition contains recycled elastomeric particles and pigmented elastomeric particles and comprises, by weight, about 68% to about 83% of recycled elastomeric particles; about 10% to about 15% of pigmented elastomeric particles; about 2.0% to about 20% of an adhesive phase; and about 0.05% to about 2% of a biocidal agent. In a particular embodiment, a composition comprises, by weight, about 68% to about 83% of the recycled elastomeric particles; about 10% to about 15% of the pigmented elastomeric particles; about 2.0% to about 20% of the adhesive phase; and about 0.05% to about 2% of the biocidal agent, wherein the recycled elastomeric particles contain SBR, the pigmented elastomeric particles contain EPDM, the adhesive phase contains polyurethane, and the biocidal agent is zinc pyrithione, N-butyl-1,2-benzisothiazolin-3-one, or silver.

In another embodiment, there is provided a method for preparing an elastomeric composition. The method comprises (a) preparing elastomeric particles; (b) mixing a biocidal agent, an adhesive phase and the elastomeric particles together to form a mixture; and (c) curing the mixture of step (b). In a particular embodiment, the elastomeric particles of the step (a) are prepared by granulation of a reclaimed rubber product. When reclaimed tires are used, for example, steel and fluff is removed leaving tire rubber with a granular consistency. To prepare particles, scrap tires are subject to processing involving removal of metallic and fabric reinforcements, shredding and granulation of the rubber, separation of non-rubber components, and sizing of the resultant particles.

In an embodiment, step (b) may comprise a two-step process of (i) preparing an adhesive phase solution by mixing an adhesive phase with a biocidal agent dispersed in an inert liquid carrier and (ii) adding the adhesive phase solution containing the biocidal agent to elastomeric particles. For example, the mixing process may contain the following steps: (i) the biocidal agent is first dispersed in an inert liquid carrier such as a hydrocarbon oil or synthetic oil or plasticizer, and the dispersed biocidal agent is then mixed with moisture curable polyurethane adhesive binder; and (ii) the binder/biocidal agent mixture is mixed with granulated rubber components in a large mechanical mixer.

The term “curing” of step (c) refers to the polymerization or hardening of a polymer material by cross-linking or chain extension of polymer chains, brought about by chemical reaction, chemical additives, ultraviolet radiation, electron beam or heat. Any conventional curing method can be used in a method of the present disclosure so long as it can aggregate the components of an elastomeric composition. In an embodiment, the curing of step (c) is carried out under compression. An exemplary compression process includes the following steps: (i) the final mixture is transferred to a large cylindrical mold and compressed with a hydraulic ram to a target density; and (ii) the compressed mixture is allowed to cure through reaction of a moisture curable polyurethane with residual moisture or intentionally-added water to form the final elastomeric article.

In an embodiment, a method in accordance with the present disclosure is carried out with about 0.05 to about 2 weight % of the biocidal agent, about 2.0 to about 20 weight % of the adhesive phase, and about 78% to about 98% of the elastomeric particles. In another embodiment, both reclaimed and pigmented elastomeric particles are used to prepare a composition and the method is carried out with about 68% to about 83% of the recycled elastomeric particles; about 10% to about 15% of the pigmented elastomeric particles; about 2.0% to about 20% of the adhesive phase; and about 0.05% to about 2% of the biocidal agent.

A method of the present disclosure can be performed with any of the components specifically described above. In an embodiment, a method is carried out with any of the proportions described above, wherein the recycled elastomeric particles contain SBR, the pigmented elastomeric particles contain EPDM, the adhesive phase contains polyurethane, and the biocidal agent is zinc pyrithione, N-butyl-1,2-benzisothiazolin-3-one, or silver.

In yet another embodiment, there is provided an elastomeric sheet having biocidal properties fabricated using a composition comprising, by weight, about 78% to about 98% of pre-fabricated elastomeric particles; about 2.0% to about 20% of an adhesive phase; and about 0.05% to about 2% of a biocidal agent, wherein the pre-fabricated elastomeric particles and the adhesive phase are made of different materials, and wherein the biocidal agent is present in the adhesive phase but is substantially absent from the pre-fabricated elastomeric particles. The components of an elastomeric sheet are as described above.

In various embodiments, an elastomeric sheet of the present disclosure optionally or entirely contains pigmented elastomeric particles. In an embodiment, an elastomeric sheet contains both recycled elastomeric particles and pigmented elastomeric particles where the recycled elastomeric particles are prepared from SBR, the pigmented elastomeric particles are prepared from EPDM, the adhesive phase contains polyurethane; and the biocidal agent is zinc pyrithione, N-butyl-1,2-benzisothiazolin-3-one, or silver. Typically, the material derived from the curing of elastomeric granules+binder+biocidal agent mixture is an elastomeric solid of a configuration such that it can be skived into elastomeric sheet at target thickness, which can then be cut into tiles or other configurations.

An elastomeric sheet of the present disclosure can be used in any conventional rubber products. Examples of such elastomeric products include, but are not limited to, supporting medium, protective cover and decorative pad. In a particular embodiment, an elastomeric sheet is used as a resilient elastomeric flooring mat. More particularly, a flooring mat may be used as pet flooring, commercial flooring, stall mats, park surfacing, playground surfacing, fitness mats, sub-floor mats, rubber tiles and cargo mats. A product containing an elastomeric sheet of the present disclosure is useful to prevent spread of communicable diseases since the biocidal agent in the product prevents proliferation of pathogenic microorganisms.

### EXAMPLES

### Example 1

### Sampling Microbes in the Environment

To identify the types of microorganisms that colonize heavily on rubber products, samples were taken from 12 different sites, primarily from rubber flooring or other similar rubber products. The sample sites were heavily trafficked areas such as a gymnasium, an indoor play area and an outdoor play area. An 11 cm×11 cm area was sampled using a sterile cotton swab and three swabs were taken from each sampling site. Two swabs were streaked onto Brain Heart Infusion (BHI) plates and incubated at 25° C. & 37° C. for bacterial growth. One swab was streaked onto Saboraud Dextrose Agar (SDA) and incubated at 30° C. for fungal growth. Later, the samples were streaked onto Cooke Rose Bengal Agar which is a more selective medium for fungi. The plates were incubated at 30° C. and observed for fungal growth. The number and variety of bacteria was observed. Types of bacteria were differentiated by the size & shape of bacteria after Gram staining. Further bacterial identification was carried out by differential staining methods and growth on differential media. Methicillin resistance of Staphylococcus aureus strains was determined by incubation with filter paper disc containing antibiotic. Fungal identification was initiated by observing colony morphologies and differential stains and growth on differential media.

A variety of microbes were recovered at all sample sites. It was notable that potential pathogenic and opportunistic bacteria were isolated from all sample sites. Common species found were microbes that normally inhabit human skin and mucosal tissues, and less commonly strains were microorganisms associated with the intestines or feces. Gram-positive bacteria (cocci, rods & tetrads) were the most common. A less abundant number of rod-shaped Gram-negative bacteria was also found at all sample sites. Among the Gram positive rods, Bacillus subtilus and Bacillus cereus were the most common, along with other soil bacteria. Among the Gram-positive cocci, Staphylococcus spp. were most frequently found. S. aureus was found at all sample sites with the exception of one outdoor park site. Samples taken from a gymnasium showed abundant microbial growth. Importantly, Methicillin-Resistant Staphylococcus aureus (MRSA) isolates was found from samplings at a gymnasium. Table 1 summarizes microorganisms isolated from various sample sites.

TABLE 1
Microorganisms isolated from various sample sites

| Sampling Sites | Gram (−) | Gram (+) |
|---|---|---|
| Gymnasiums | Citrobacter spp. (OP) | MRSA (P) |
| | Kingella spp. (P) | Staphylococcus epidermidis (OP) |
| | Listeria spp. (P) | Actinomycetes spp. |
| | Enterobacter agglomerans (G) | Deinococcus spp. (S) |
| | Shigella spp. (P) | Brochothrix thermosphacta |
| Indoor Play Areas | Acinetobacter hemolytica (OP) | Micrococcus kristinae (OP) |
| | Enterobacter agglomerans (G) | Actinomycetes spp. (S) |
| | | Staphylococcus aureus (P) |
| | | Staphylococcus epidermidis (OP) |
| Outdoor Play Areas | Proteus mirabilis (P) | Staphylococcus aureus (OP) |
| | Citrobacter freundii (OP) | |
| | Enterobacter agglomerans (G) | |

P = Possible human pathogen,
OP = Opportunistic human pathogen,
S = Soil dwelling,
G = Gut inhabitant

### Example 2

### Preparation of Compositions 1A-1D

The following examples describe four compositions used in preparing a biocidal composition in a comparative study. The compositions made and tested are shown in Table 2, where the amount of each component is expressed in weight %.

TABLE 2
Compositions containing zinc pyrithione as a biocidal agent

| | Amount in Compositions | | | |
|---|---|---|---|---|
| | Composition | Composition | Composition | Composition |
| | 1A | 1B | 1C | 1D |
| Components | (weight %) | (weight %) | (weight %) | (weight %) |
| Recycled SBR | 75 | 75 | 75 | 75 |
| Pigmented | 13 | 13 | 13 | 13 |
| EPDM | | | | |
| Polyurethane | 12 | 11.95 | 11.90 | 11.85 |
| Zinc Pyrithione | 0 | 0.05 | 0.10 | 0.15 |

In these examples, the recycled elastomeric granules (made of SBR) were derived from reclaimed tires, and the pigmented elastomeric granules (made of EPDM) were prepared by vulcanizing or polymerizing backbone EPDM polymers mixed with colorants. The elastomeric materials were granulated and classified by size using conventional processes. The zinc pyrithione powder, available from Arch Chemicals, Inc, was dispersed in an inert liquid carrier, i.e., a hydrocarbon ester plasticizer, and the dispersed biocidal agent was then mixed with moisture-curable polyurethane adhesive. The polyurethane and zinc pyrithione mixture was then mixed with the SBR and EPDM granules at a specific weight ratio (shown in Table 2) in a mechanical mixer. The final mixture was transferred to a cylindrical mold and compressed with a hydraulic ram to a target density. The compressed mixture was allowed to cure through reaction with residual moisture and intentionally-added water. The cured product from the rubber+polyurethane+zinc pyrithione mixture formed a cylindrical elastomeric “log”, which can be skived at target thickness to produce rubber rolls that might be cut into tiles or other configurations.

### Example 3

### Biological Assay

### Zone of Inhibition Assay

The biocidal efficacy of the compositions was tested to evaluate their capability to inhibit the growth of certain microorganisms. Compositions 1A to 1D having varying levels of zinc pyrithione (from 0 to 0.15 weight %) were subject to a zone of inhibition assay. The plates used in the assay were inoculated with Staphylococcus aureus and two methicillin-resistant Staphylococcus aureus (MRSA) strains (labeled as MRSA1 and MRSA2). The microorganisms were isolated from public places during the samplings. Each of the bacterial samples was streaked onto the Mueller Hinton agar plate using a sterile cotton swab so that a lawn of bacterial growth could be obtained on the plate. A 10 mm×10 mm rubber sample was placed in the center of the plate so that it contacted the agar surface. The plates were incubated at 37° C. and the zone of inhibition was observed. The diameter of the zone of inhibition (i.e., area showing no bacterial growth) was measured after about 18 to 22 hours of incubation, where the diameter positively correlates to the antibacterial activity of the rubber sample. The results of these tests are shown in the following table.

TABLE 3
Zone of Inhibition assay results

| | Zinc | | | |
|---|---|---|---|---|
| | Pyrithione | | | |
| | (weight %) | S. aureus | MRSA2 | MRSA1 |
| Composition | 0 | −− | −− | −− |
| 1A | | | | |
| Composition | 0.05 | −− | −− | −− |
| 1B | | | | |
| Composition | 0.10 | +++ (16 mm) | + (10 mm) | −− |
| 1C | | | | |
| Composition | 0.15 | +++ (15 mm) | + (10 mm) | ++ (13 mm) |
| 1D | | | | |

The diameter of the zones of inhibition are represented in millimeters (mm)
+++: Complete clearing
++: Good clearing
+: Incomplete clearing
−−: No zone of inhibition

The results show that when contacted with microorganisms frequently found in public places, Compositions 1C and 1D inhibited the growth of such microorganisms.

### Example 4

### Preparation of Compositions 2A to 4D

Three additional sets of compositions were prepared by the same method as described in Example 2 with three different biocidal agents. Each set contains zinc pyrithione, N-butyl-1,2-benzisothiazolin-3-one and silver, respectively, as a biocidal agent. Table 4 shows the components of Compositions 2A through 2D containing zinc pyrithione and their amounts. The compositions were prepared with a commercially available chemical, Zinc Omadine®.

TABLE 4
Compositions containing zinc pyrithione as a biocidal agent

| | Amount in Compositions | | | |
|---|---|---|---|---|
| | Composition | Composition | Composition | Composition |
| | 2A | 2B | 2C | 2D |
| Components | (weight %) | (weight %) | (weight %) | (weight %) |
| Elastomeric | 90 | 90 | 90 | 90 |
| particles | | | | |
| Polyurethane | 10 | 9.9 | 9.8 | 9.7 |
| Zinc | 0 | 0.1 | 0.2 | 0.3 |
| Omadine ® | | | | |

Table 5 shows the components of Compositions 3A through 3D containing N-butyl-1,2-benzisothiazolin-3-one and their amounts. The compositions were prepared with a commercially available chemical, Vanquish™ 100.

TABLE 5
Compositions containing N-butyl-1,2-benzisothiazolin-3-one
as a biocidal agent

| | Amount in Compositions | | | |
|---|---|---|---|---|
| | Composition | Composition | Composition | Composition |
| | 3A | 3B | 3C | 3D |
| Components | (weight %) | (weight %) | (weight %) | (weight %) |

| | | | | |
|---|---|---|---|---|
| Elastomeric | 90 | 90 | 90 | 90 |
| particles | | | | |
| Polyurethane | 10 | 9.95 | 9.9 | 9.8 |
| Vanquish ™ | 0 | 0.05 | 0.1 | 0.2 |
| 100 | | | | |

Table 6 shows the components of Compositions 4A through 4D containing silver and their amounts. The compositions were prepared with a commercially available chemical, Irgaguard® B-6000.

TABLE 6
Compositions containing silver as a biocidal agent

| | Amount in Compositions | | | |
|---|---|---|---|---|
| | Composition | Composition | Composition | Composition |
| | 4A | 4B | 4C | 4D |
| Components | (weight %) | (weight %) | (weight %) | (weight %) |
| Elastomeric | 90 | 90 | 90 | 90 |
| particles | | | | |
| Polyurethane | 10 | 9.75 | 9.5 | 9.3 |
| Irgaguard ® | 0 | 0.25 | 0.5 | 0.7 |
| B-6000 | | | | |

### Example 5

### Biological Assay

### Direct Contact Assay

The three sets of compositions, i.e., Compositions 2A through 4D, were subject to a direct contact assay. A single isolated colony of bacteria was inoculated to BHI broth and cultured overnight by incubating on a shaker at 37° C. Serial dilutions were performed with the overnight cultures (10⁻¹ to 10⁻⁸ dilutions). Bacteria on a BHI plate were incubated at 37° C. for about 18 to 22 hours and the number of Colony Forming Units (CFU) on each plate was counted. An inoculum of 2-3×10⁵ CFU/ml was obtained and then 0.2 ml of 2-3×10⁵ CFU/ml of inoculum was added to a 25 mm×25 mm of Compositions 2A to 4D. Two of each composition were inoculated. The compositions were covered with inoculum using a 20 mm×20 mm sterile glass cover slip like a sandwich. In this assay, the inoculum used for testing the compositions was diluted in artificial perspiration to mimic the natural growth conditions of microbes. The bacteria were incubated at 37° C. for 1, 2, 4 and 24 hours to evaluate growth inhibition of Compositions 2A to 4D. After 24 hours, the test bacteria were washed out from both the cover slip and rubber sample using 3 ml of sterile phosphate buffered saline.

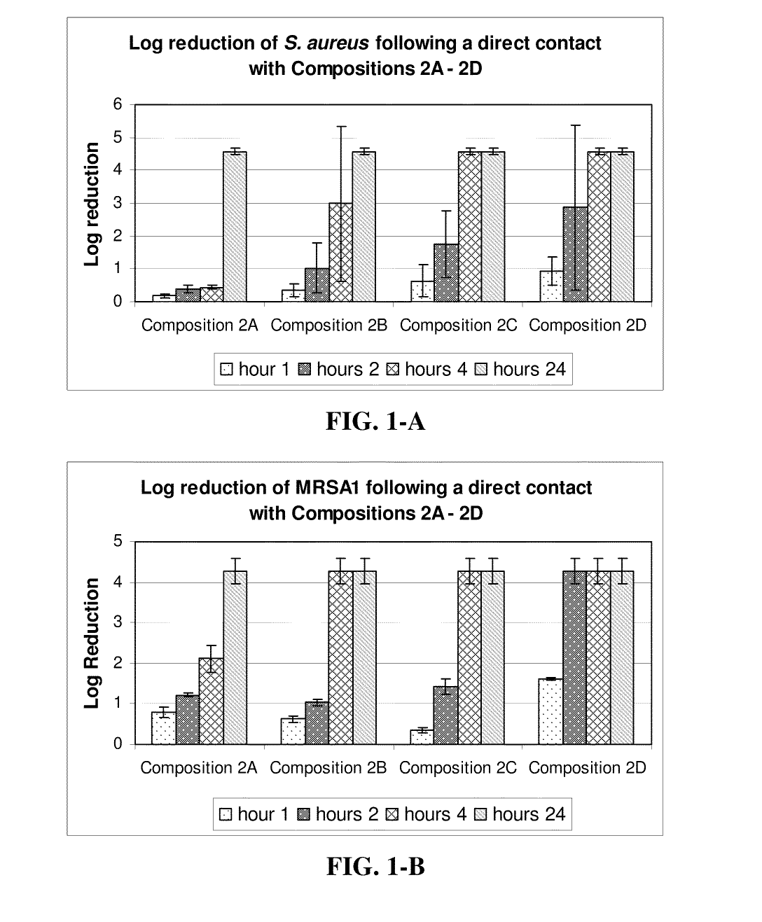

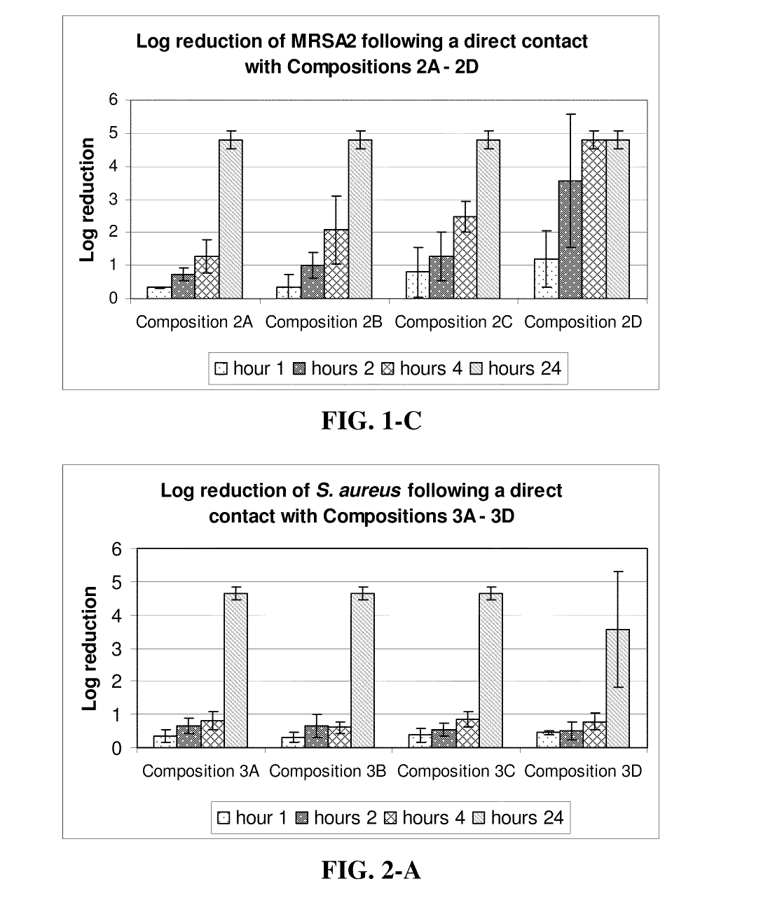

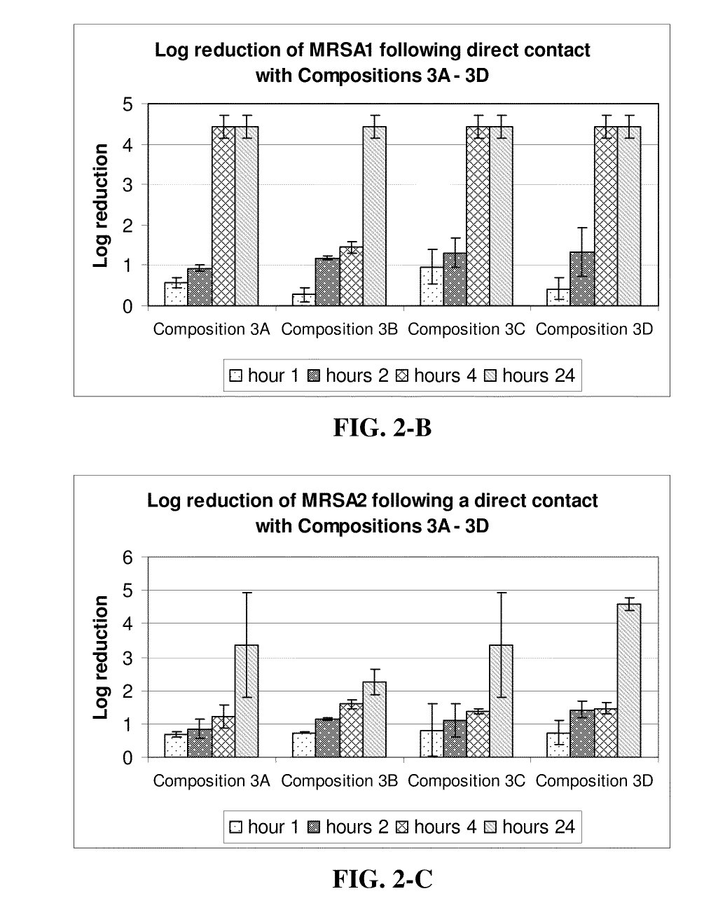

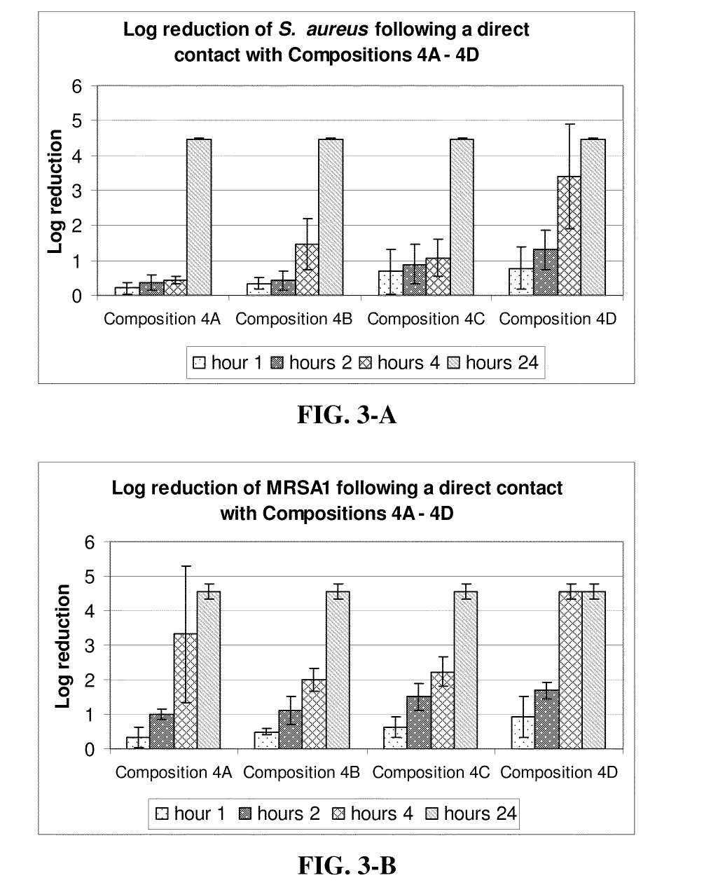

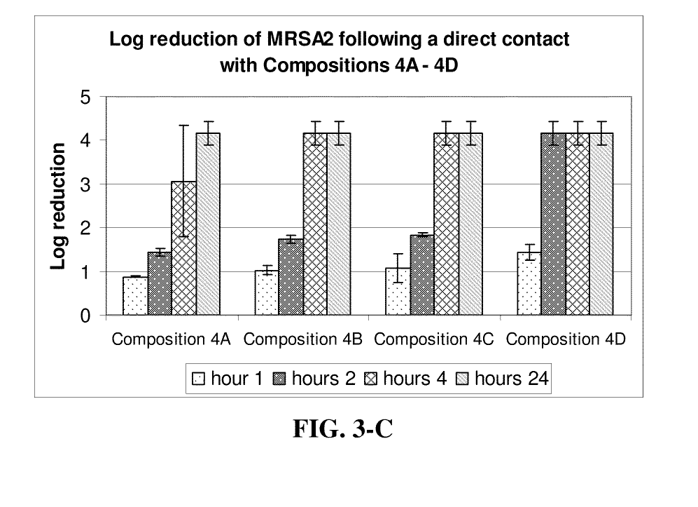

FIGS. 1-A through 3-C show the results from the direct contact assay against various bacteria with Compositions 2A to 4D where the reduction of bacterial growth was shown in log scale. Each composition set was tested against S. aureus, MRSA1 and MRSA2, respectively, and the growth reduction was recorded at 1, 2, 4 and 24 hours. The results in FIGS. 1-A through 3-C demonstrate that a composition containing any of the biocidal agents in accordance with the present disclosure is effective to reduce the growth of bacteria found in public areas. This suggests that a product containing such a composition would prevent spread of communicable diseases without additional maintenance.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed. Example embodiments may be embodied in many different forms and that none of those embodiments should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a”, “an” and “the” may be intended to include the plural forms as well, unless the context clearly indicates otherwise. The terms “comprise,” “comprising,” “contain,” “containing,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

Although the terms first, second, third, etc. may be used herein to describe various elements, components, regions, layers and/or sections, these elements, components, regions, layers and/or sections should not be limited by these terms. These terms may be used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

What is claimed is:

1. A composition having biocidal properties comprising:
pre-fabricated elastomeric particles,
a biocidal agent, and
an adhesive phase combining the pre-fabricated elastomeric particles and the biocidal agent,
wherein the pre-fabricated elastomeric particles and the adhesive phase are made of different materials, and
wherein the biocidal agent is present in the adhesive phase but is substantially absent from the pre-fabricated elastomeric particles.

2. The composition as claimed in claim 1, wherein the composition comprises, by weight,
about 78% to about 98% of the pre-fabricated elastomeric particles;
about 2.0% to about 20% of the adhesive phase; and
about 0.05% to about 2% of the biocidal agent.

3. The composition as claimed in claim 1, wherein the pre-fabricated elastomeric particles are about 0.2 to about 10.0 mm in diameter or length.

4. The composition as claimed in claim 1, wherein the pre-fabricated elastomeric particles comprise at least one selected from the group consisting of natural rubber, butadiene rubber, chloroprene rubber, chlorosulfonylpolyethelene rubber, epichlorohydrin rubber, ethylene-propylene diene rubber, ethylene vinyl acetate rubber, halo-butyl rubber, isobutene-isoprene rubber, nitrile-butadiene rubber, polyisoprene rubber, styrene-butadiene rubber, styrene-isoprene rubber, thermoplastic rubbers based on polyolefins, polyesters, styrene-butadiene polymers, polyurethanes, non-thermoplastic polyurethane rubbers, and plasticized polyvinyl chloride.

5. The composition as claimed in claim 1, wherein the pre-fabricated elastomeric particles are polymerized particles, recycled particles, pigmented particles, or mixtures thereof.

6. The composition as claimed in claim 1, wherein the adhesive phase comprises polyurethane.

7. The composition as claimed in claim 1, wherein the biocidal agent is selected from the group consisting of pyrithione acid, sodium pyrithione, potassium pyrithione, pyrithione disulfide magnesium sulfate, zinc pyrithione, silver in zeolite matrix, zinc in zeolite matrix, copper in zeolite matrix, tributyl tin oxide (TBTO), tributyl tin maleate (TBTM), para-chloro-xylene, hexachlorophene, 2,4,4′ trichloro-2′-hydroxydiphenyl ether (triclosan), imazalil sulphate, 3,5,3′,4′-tetrachlorosalicylanilide, N-nitroso-N-cyclohexyl hydroxylamine, 8-hydroxyquinoline, copper-8-hydroxy quinolinate, thiocarbamates, dithiocarbamates, zinc dimethyldithiocarbamate, 5-chloro-2-(2,4-dichlorophenoxy)phenol, polyhexamethylene biguanide hydrochloride, 2-phenylphenol, diiodomethyl-4-tolylsulfone, zinc-2-mercaptopyridine-N-oxide, N-alkyl-N,N-dimethyl-N-benzylammonium chloride, 3-(4-chlorophenyl)-1-(3,4-dichlorphenyl)urea (triclocarban), 2-(1,3-thiazol-4-yl)-1H-benzoimidazole (thiabendazole), 3-iodo-2-propynyl N-butylcarbamate, 3-benzo[b]thien-2-yl-5,6-dihydro-1,4,2-oxathiazine 4-oxide, 2-(n-octyl)-3(2H)-isothiazolone (OIT), N-butyl-1,2-benzisothiazolin-3-one, 4,5-dichloro-2-octyl-3(2H)-isothiazolone, 2-methyl-4-isothiazoline-3-one cyclopropyl-N′-(1,1-dimethylethyl)-6-methylthio-1,3,5-triazine-2,4-diamine, 1,3-dicyano-2,4,5,6-tetrachlorobenzene, 3,4,4′-trichlorocarbanilide, 3-(3,4-dichlorophenyl)-1,1-dimethylurea (DIURON), 1 [[2-(2,4-dichlorophenyl)-4-propyl-1,2-dioxolan-2-yl]methyl]-1H-1,2,4-triazole (propiconazole), 10,10-oxybisphenoxy arsine (OBPA), 1-(4-chlorophenyl)-4,4-dimethyl-3-(1,2,4-triazol-1-ylmethyl)pentan-3-ol (tebuconazole), 2-(thiocyanomethylthio)benzothiazole, 2,3,5,6 tetrachloro-4-(methyl sulphonyl)pyridine, 2,4,4-tricloro-2-hydroxydiphenylether, 4-chloro-3,5-dimethyl-phenol, 5-hydroxymethoxymethyl-1-1aza-3,7-dioxabicyclo-octane, 2,4,5,6-tetrachloro-1,3-benzenedicarbonitrile (chlorothalonil), bis(tri-n-butyltin)oxide, N-(fluorodichloromethylthio)phthalimide, N-(trichloromethyl-thio)-4-cyclohexene-1,2-dicarboximide, N,N-dimethyl dichlorophenyl urea, p-chloro-m-cresol, o-phenylphenol, pentachlorophenol, silver compounds, sodium-o-phenyl phenoxide, tebuconazole, tetrachloroisophthalonitrile, tetramethylthiuram disulfide and a mixture thereof.

8. The composition as claimed in claim 1, wherein the pre-fabricated elastomeric particles comprise recycled elastomeric particles and pigmented elastomeric particles, and wherein the composition comprises, by weight, about 68% to about 83% of the recycled elastomeric particles;
about 10% to about 15% of the pigmented elastomeric particles;
about 2.0% to about 20% of the adhesive phase; and
about 0.05% to about 2% of the biocidal agent.

9. The composition as claimed in claim 7, wherein
the recycled elastomeric particles comprise SBR;
the pigmented elastomeric particles comprise EPDM;
the polymeric binder comprises polyurethane; and
the biocidal agent is zinc pyrithione, N-butyl-1,2-benzisothiazolin-3-one, or silver.

10. A method for preparing an elastomeric composition, comprising:
(a) preparing elastomeric particles;
(b) mixing a biocidal agent, an adhesive phase and the elastomeric particles together to form a mixture; and
(c) curing or polymerizing the mixture of step (b) to form an elastomeric solid.

11. The method as claimed in claim 10, wherein step (b) is a two-step process comprising:
(i) preparing an adhesive phase solution by mixing an adhesive phase, a liquid carrier and a biocidal agent, and
(ii) adding the adhesive phase solution comprising the biocidal agent to elastomeric particles, and
wherein the curing of step (c) is carried out under compression.

12. The method as claimed in claim 10, wherein the elastomeric particles of step (a) are prepared by granulation of a reclaimed elastomeric product.

13. The method as claimed in claim 10, wherein step (b) is carried out with about 0.05 to about 2 weight % of the biocidal agent, about 2.0 to about 20 weight % of the adhesive phase, and about 78% to about 98% of the elastomeric particles.

14. The method as claimed in claim 10, wherein the elastomeric particles are prepared from rubber selected from the group consisting of natural rubber, butadiene rubber, chloroprene rubber, chlorosulfonylpolyethelene rubber, epichlorohydrin rubber, ethylene-propylene diene rubber, ethylene vinyl acetate rubber, halo-butyl rubber, isobutene-isoprene rubber, nitrile-butadiene rubber, polyisoprene rubber, styrene-butadiene rubber, styrene-isoprene rubber, thermoplastic rubbers based on polyolefins, polyesters, styrene-butadiene polymers, polyurethanes, non-thermoplastic polyurethane rubbers, and plasticized polyvinyl chloride.

15. The method as claimed in claim 10, wherein the elastomeric particles are polymerized particles, recycled particles, pigmented particles or mixtures thereof.

16. The method as claimed in claim 10, wherein the adhesive phase comprises polyurethane.

17. The method as claimed in claim 10, wherein the biocidal agent is selected from the group consisting of pyrithione acid, sodium pyrithione, potassium pyrithione, pyrithione disulfide magnesium sulfate, zinc pyrithione, silver in zeolite matrix, zinc in zeolite matrix, copper in zeolite matrix, tributyl tin oxide (TBTO), tributyl tin maleate (TBTM), para-chloro-xylene, hexachlorophene, 2,4,4′ trichloro-2′-hydroxydiphenyl ether (triclosan), imazalil sulphate, 3,5,3′,4′-tetrachlorosalicylanilide, N-nitroso-N-cyclohexyl hydroxylamine, 8-hydroxyquinoline, copper-8-hydroxy quinolinate, thiocarbamates, dithiocarbamates, zinc dimethyldithiocarbamate, 5-chloro-2-(2,4-dichlorophenoxy)phenol, polyhexamethylene biguanide hydrochloride, 2-phenylphenol, diiodomethyl-4-tolylsulfone, zinc-2-mercaptopyridine-N-oxide, N-alkyl-N,N-dimethyl-N-benzylammonium chloride, 3-(4-chlorophenyl)-1-(3,4-dichlorphenyl)urea (triclocarban), 2-(1,3-thiazol-4-yl)-1H-benzoimidazole (thiabendazole), 3-iodo-2-propynyl N-butylcarbamate, 3-benzo[b]thien-2-yl-5,6-dihydro-1,4,2-oxathiazine 4-oxide, 2-(n-octyl)-3(2H)-isothiazolone (OIT), N-butyl-1,2-benzisothiazolin-3-one, 4,5-dichloro-2-octyl-3(2H)-isothiazolone, 2-methyl-4-isothiazoline-3-one cycloprop yl-N′-(1,1-dimethylethyl)-6-methylthio-1,3,5-triazine-2,4-diamine, 1,3-dicyano-2,4,5,6-tetrachlorobenzene, 3,4,4′-trichlorocarbanilide, 3-(3,4-dichlorophenyl)-1,1-dimethylurea (DIURON), 1[[2-(2,4-dichlorophenyl)-4-propyl-1,2-dioxolan-2-yl]methyl]-1H-1,2,4-triazole (propiconazole), 10,10-oxybisphenoxy arsine (OBPA), 1-(4-chlorophenyl)-4,4-dimethyl-3-(1,2,4-triazol-1-ylmethyl)pentan-3-ol (tebuconazole), 2-(thiocyanomethylthio)benzothiazole, 2,3,5,6 tetrachloro-4-(methyl sulphonyl)pyridine, 2,4,4-tricloro-2-hydroxydiphenylether, 4-chloro-3,5-dimethyl-phenol, 5-hydroxymethoxymethyl-1-1aza-3,7-dioxabicyclo-octane, 2,4,5,6-tetrachloro-1,3-benzenedicarbonitrile (chlorothalonil), bis(tri-n-butyltin)oxide, N-(fluorodichloromethylthio)phthalimide, N-(trichloromethyl-thio)-4-cyclohexene-1,2-dicarboximide, N,N-dimethyl dichlorophenyl urea, p-chloro-m-cresol, o-phenylphenol, pentachlorophenol, silver compounds, sodium-o-phenyl phenoxide, tebuconazole, tetrachloroisophthalonitrile, tetramethylthiuram disulfide and a mixture thereof.

18. The method as claimed in claim 10, wherein the elastomeric particles comprises recycled elastomeric particles and pigmented elastomeric particles, and wherein the elastomeric composition is prepared with, by weight,
about 68% to about 83% of the recycled elastomeric particles;
about 10% to about 15% of the pigmented elastomeric particles;
about 2.0% to about 20% of the adhesive phase; and
about 0.05% to about 2% of the biocidal agent.

19. The method as claimed in claim 18, wherein
the recycled elastomeric particles comprise SBR,
the pigmented elastomeric particles comprise EPDM,
the polymeric binder comprises polyurethane, and
the biocidal agent is zinc pyrithione, N-butyl-1,2-benzisothiazolin-3-one, or silver.

20. An elastomeric sheet having biocidal properties fabricated from a composition comprising, by weight,
about 78% to about 98% of pre-fabricated elastomeric particles;
about 2.0% to about 20% of an adhesive phase; and
about 0.05% to about 2% of a biocidal agent,
wherein the pre-fabricated elastomeric particles and the adhesive phase are made of different materials, and
wherein the biocidal agent is present in the adhesive phase but is substantially absent from the pre-fabricated elastomeric particles.

21. The elastomeric sheet as claimed in claim 20, wherein the pre-fabricated elastomeric particles are about 0.2 to about 10.0 mm in diameter or length.

22. The elastomeric sheet as claimed in claim 20, wherein the pre-fabricated elastomeric particles are recycled crumb rubber.

23. The elastomeric sheet as claimed in claim 20, wherein
the pre-fabricated elastomeric particles comprise recycled elastomeric particles prepared from SBR and pigmented elastomeric particles prepared from EPDM;
the adhesive phase comprises polyurethane; and
the biocidal agent is zinc pyrithione, N-butyl-1,2-benzisothiazolin-3-one, or silver.

24. The elastomeric sheet as claimed in claim 20, wherein the elastomeric sheet is used as supporting medium, protective cover or decorative pad.

25. The elastomeric sheet as claimed in claim 24, wherein the supporting medium is a resilient elastomeric flooring mat.
